(19) United States
(12) Patent Application Publication
(10) Pub. No.: US 2017/0141862 A1
(43) Pub. Date: May 18, 2017

(54) A SYSTEM, METHOD, SOFTWARE APPLICATION AND DATA SIGNAL FOR DELIVERING CONTENT

(71) Applicant: LUNALITE INTERNATIONAL PTY LTD, West Perth (AU)

(72) Inventor: Steve WILDISEN, Bicton (AU)

(21) Appl. No.: 15/322,383

(22) PCT Filed: May 18, 2015
(86) PCT No.: PCT/AU2015/000293

§ 371 Date: Dec. 27, 2016

(30) Foreign Application Priority Data
Jun. 30, 2014 (AU) 2014902499

(51) Int. Cl. H04H 20/62; H04H 60/06; H04L 29/08

(52) U.S. Cl. CPC H04H 20/62; H04L 67/12; H04H 60/06

(57) ABSTRACT

A system for delivering content, comprising: a local server arranged to provide multimedia content to a device, and a sensor in communication with the local server; wherein the sensor monitors for an event, and on the sensor being triggered by the occurrence of the event, the sensor sends a signal to the local server to cause the local server to modify the provision of content to the device.

### TECHNICAL FIELD/FIELD OF THE INVENTION

The present invention relates to a system, method software application and data signal for delivering content and in particular, to a system, method, software application and data signal that is capable of delivering content in a public space in response to changing environmental factors, such as the proximity of vehicles to a location.

Embodiments of the invention have been developed primarily for use in railway stations, where opportunities exist to deliver information, advertisements and other visual and aural content to commuters. It will be understood that while the embodiment described herein is directed to a system that is utilised in a railway station, the system may find use in any suitable situation where content needs to be delivered to an audience, particularly where changing environmental factors make conventional delivery of content problematic.

### BACKGROUND ART

The following discussion of the background art is intended to facilitate an understanding of the present invention only. The discussion is not an acknowledgement or admission that any of the material referred to is or was part of the common general knowledge as at the priority date of the application.

It is known to use otherwise ‘blank’ space in many publicly accessible areas to provide traditional print media advertising (e.g. posters, etc.). In particular, underground railway stations provide a large amount of blank space, particularly at train platforms and it is well known to provide conventional, traditional print media advertisements at such locations. In addition, as traditionally commuters have had little or nothing to keep them occupied while waiting for a train to arrive at a platform, their eye is easily drawn to the advertisement.

With the advent of greatly improved mobile telecommunications (including mobile data) Wireless Internet connections, small portable devices such as ‘smartphones’ and ‘tablet computers’, commuters are now easily distracted by their smartphones and tablet computers, and largely ignore traditional advertising. In other words, the effectiveness of traditional advertising in train stations, bus stations, public places, etc., has diminished greatly. Similarly, commuters generally ignore ‘static’ warning signs, as they are bombarded with so much content that they learn to ‘tune out’ any signs, advertisements, etc.

It is against this background that the current invention has been developed.

In the proceeding description, reference is made to ‘commuters’. It will be understood that in the ensuing description, the term ‘commuter’ is used only to provide context to the example embodiments described, and that the term ‘commuter’ should not be given any ‘gloss’ which is then used to narrow or otherwise limit any of the features of the embodiments or the broader invention described herein. A ‘commuter’, for the purposes of the specification, is merely a person who views/hears multimedia content and information.

### SUMMARY OF INVENTION

In a first aspect, the present invention provides a system for delivering content, comprising:

a local server arranged to provide multimedia content to a device, and a sensor in communication with the local server;

wherein the sensor monitors for an event, and on the sensor being triggered by the occurrence of the event, the sensor sends a signal to the local server to cause the local server to modify the provision of content to the device.

The system may further include a central server arranged to provide content to the device. The local server may further include a scheduling module, arranged to provide one or more of a plurality of multimedia content to the device in a predetermined order.

In turn, the scheduling monitor may receive additional scheduling information wherein the additional scheduling information is utilised by the scheduling module to modify the predetermined order of the content.

The local server may be arranged to autonomously retrieve content from at least one external source.

The local server may be arranged to, upon receiving the trigger event from the sensor, cause the device stop displaying the content.

In one embodiment, at least one of the sensor and the local server, and the local server and the remote server communicate wirelessly.

In embodiments where there are provided a plurality of devices, the local server provides content to each of the plurality of devices.

In one embodiment, there are provided a plurality of local servers which form a network of local servers, each local server being associated with one or more devices, wherein each one of the plurality of local servers is arranged to synchronise with each other, such that similar content is provided to each one of the one devices under the control of the plurality of local servers.

The multimedia content may include at least one of advertisements, entertainment and emergency announcements.

The device may be a multimedia screen, such as a LED monitor.

In one embodiment, the system is partially or wholly located within a railway station.

In a second aspect, the present invention provides a method for delivering content, comprising the steps of:

providing multimedia content to a device via a local server, and monitoring for an event, via a sensor;

wherein on the sensor being triggered by the occurrence of the event, a signal is sent to the local server to cause the local server to modify the provision of content to the device.

In a third aspect, the present invention provides a computer program including at least one instruction which, when executed on a computing system, causes the computing system to carry out the method steps in accordance with the second aspect of the invention.

In a fourth aspect, the present invention provides a computer readable medium incorporating a computer program in accordance the third aspect of the invention.

In a fifth aspect, the present invention provides a data signal including at least one executable instruction, which, when received by a computing system, causes the computing system to carry out the method steps in accordance with the second aspect of the invention.

### BRIEF DESCRIPTION OF THE DRAWINGS

Notwithstanding any other embodiments that may fall within the scope of the present invention, an embodiment of the present invention will now be described, by way of example only, with reference to the accompanying figures, in which:

FIG. 1 is an example computing system and network that may be utilised to operate a system, method and/or software application in accordance with the present invention;

FIG. 2 is a schematic diagram of an example system in accordance with an embodiment of the present invention;

FIG. 3 is a representation of a screen in accordance with an embodiment of the invention, in situ in a railway station; and

FIGS. 4 and 5 are flowcharts depicting process steps in accordance with an embodiment of the invention.

### DESCRIPTION OF PREFERRED/SPECIFIC EMBODIMENTS

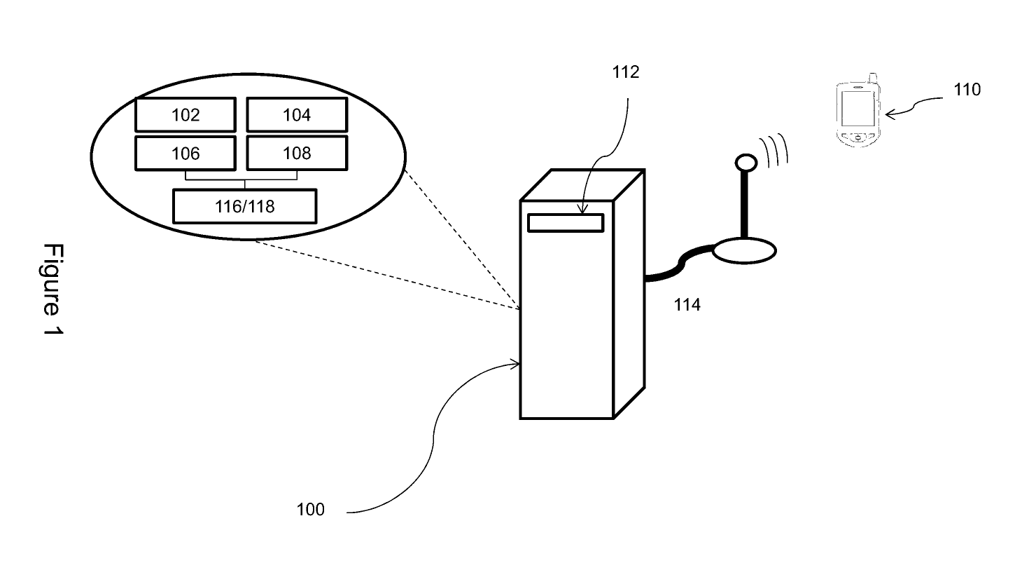

In the proceeding description, reference is made to the use of one or more ‘servers’. Referring to FIG. 1, an embodiment of a server utilised as a part of the present invention is illustrated.

Referring to FIG. 1 in more detail, there is a shown a schematic diagram of a content delivery system which in this embodiment comprises a server 100. The server 100 comprises suitable components necessary to receive, store and execute appropriate computer instructions. The components may include a processing unit 102, read only memory (ROM) 104, random access memory (RAM) 106, and input/output devices such as disk drives (including solid state drives or any other storage technology as used depending on the specific hardware/software combination) 108, input devices 110 such as a mobile work station (although it will be understood that more conventional input devices such as keyboards, mice, etc. are contemplated). Display 112 such as a liquid crystal display, a light emitting display or any other suitable display and communications links 114.

The server 100 includes instructions that may be included in ROM 104, RAM 106 or disk drives 108 and may be executed by the processing unit 102. There may be provided a plurality of communication links 114 which may variously connect to one or more computing devices such as a server, personal computers, terminals, wireless or handheld computing devices. At least one of a plurality of communications link may be connected to an external computing network through a wireless link (e.g. satellite), optical fibre, Ethernet, telephone line or other type of communications link.

It will be understood that in some embodiments, the communications link 114 may be or include a link to a wireless telecommunications network, which is colloquially referred to as a “mobile” or “cell” phone network. The server 100 may include an interface arranged to receive a Subscriber Identification Module (SIM) (not shown) to allow the server 100 to connect and transmit data across a Global System for Mobile Communications (GSM) network, which is a standard developed by the European Telecommunications Standards Institute (ETSI) to describe protocols for second generation (2G) digital cellular networks used by mobile phones. It will also be understood that the server 100 may also be able to utilise 3rd Generation (3G) and 4th Generation (4G) telecommunications networks (extensions of the GSM network standard), or any other specific hardware or software required to connect with any suitable network, as may become available over time as new telecommunications networks and protocols are developed. It is therefore intended that the examples of suitable networks described here are provided for the purposes of illustration only and are not intended to limit the scope of the claimed invention.

The service may include storage devices such as a disk drive 108 which may encompass solid state drives, hard disk drives, optical drives or magnetic tape drives. The server 100 may use a single disk drive or multiple disk drives. The server 100 may also have a suitable operating system 116 which resides on the disk drive or in the ROM of the server 100.

In turn, there is provided an application or applications 118 which interact with the operating system 116 and/or directly with the aforementioned hardware components to carry out the method steps of the embodiments described herein. The application or applications 118, taken together with the server 100, form part of the broader system described and defined herein. In some embodiments, the application or applications 118 may reside on a computer readable media such as disk drives 108. Alternatively, application or applications 118 may be provided to the server 100 as a data signal via communications link 114.

In the ensuing description, for the sake of clarity, and in the context of the embodiment described, reference will be made to a ‘central server’ (a computing system utilised to distribute content to one or more local servers) and a ‘local server’ (application server utilised to control various hardware devices and components).

However, it will be understood that these identifiers/labels are utilised only for the sake of providing a clear and easily understood example, and no gloss should be taken from these labels to limit the scope of the embodiment, any features of the embodiment, or the broader invention described herein. In particular, the labels ‘central’ and ‘local’ are not be interpreted literally, as it is possible that both servers may be physically co-located in the same geographical area, or, in another embodiment, one physical computing system may run more than one ‘virtual’ server, such that the central server and the local server reside on a single physical hardware device. Such variations are encompassed by the broadest aspects of the invention described herein.

Moreover, where a ‘real world’ product is referred to in the description, the name of the product is marked with a “™” to denote a brand/mark. Where a brand name is used to describe a product, the intention of the writer is to provide a ‘real world’ example and again, no gloss should be taken from the use of branded examples to limit the scope of the embodiment, any features of the embodiment, or the broader invention described herein.

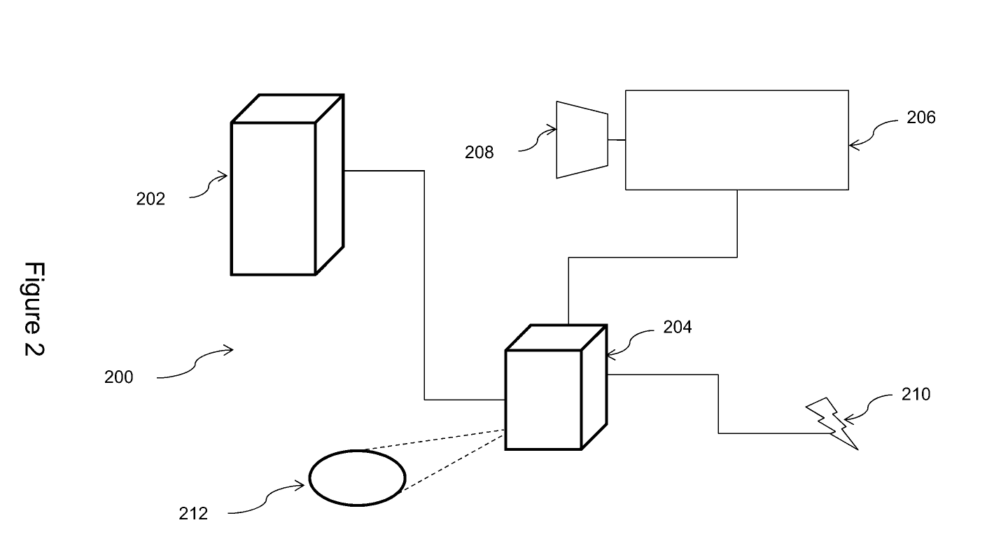

Referring now to FIG. 2, there is shown a system in accordance with an embodiment of the present invention. The system 200 includes a central server 202 which is in communication with a local server 204. The local server 204 is in communication with a display screen 206 and associated speakers 208, and the local server 204 is also in communication with at least one sensor 210.

In the context of an underground train station, it will be understood that while in some train stations there may be mobile telecommunications repeaters, such that a pre-existing wireless communications network (i.e. a mobile telephone communications network) may be utilised to communicate between the central server 202, the local server 204 and the display screen and associated speakers 208, there may be situations where such networks are not available and also where conventional ‘cabled’ communication may not be practical or possible. In such situations, the embodiment described herein contemplates a communications link being established using antennas which may transmit data and information using any suitable protocol, such as an IEEE 802.11 Standard Protocol (also referred to as ‘Wi-Fi’).

Where it is desired to have only wireless transmission within an underground railway, repeater antennas may be installed along the tunnel with a final antenna being positioned at the mouth of the tunnel with at least a portion of the tunnel interior being within the transmitting and receiving beam widths of the antenna, such that no telecommunications cabling need be run into the railway tunnel. Such variations to the communications infrastructure are contemplated and form part of the embodiments described herein.

In brief, data and information which is initially uploaded to the central server 202 is communicated to the local server 204. The local server 204 displays and/or conveys the data and information on the display screen 206 and/or through the associated speakers 208, upon receiving input from the at least one sensor 210.

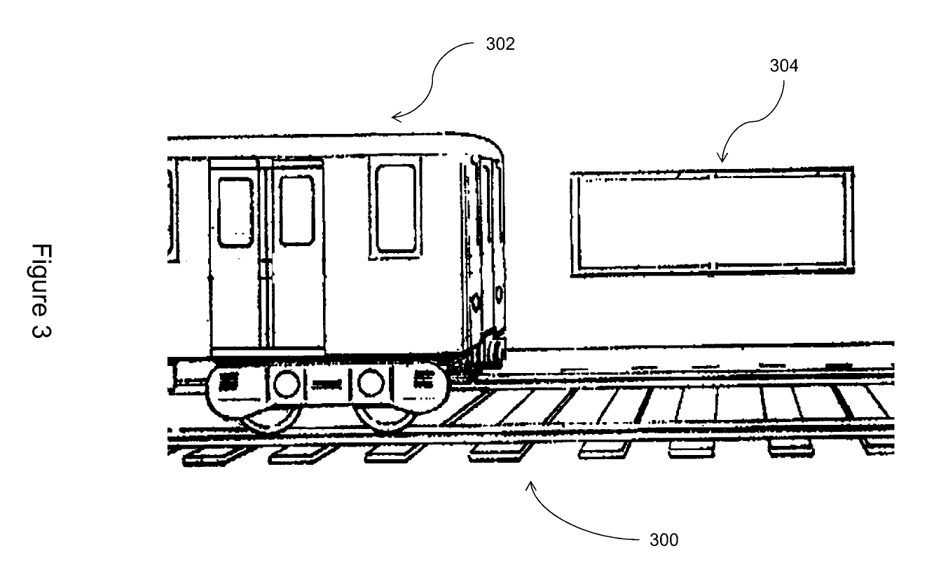

In more detail, the central server 202 is arranged to contain data and information to be communicated to the local server 204. In the embodiment described herein (which is described in more detail later with reference to FIG. 3), the data and information includes at least one of the following:
1. advertising information, which may include ‘still’ advertisements, video advertisements, aural advertisements, or any other type of advertisement conveyable via a display screen and/or a set of audio speakers;
2. information regarding the immediate environment, including news and weather information, warning messages, emergency warnings, community service announcements, etc.; and
3. entertainment information, such as music, television programs, films, etc.

The data and information may be uploaded to the central server 202 in any suitable manner and via any suitable channel and/or person. For example, in one embodiment, there may be one or more operators who have access to the central server 202 and upload data and information from time to time, as required. Alternatively, the central server 202 may be semi-automated or fully automated, in that the central server may access another source of data or information, such as a third party server (not shown) and may automatically download and update the data and information on a periodic or ad hoc basis.

The data and information may then be communicated to the local server 204 on a periodic or ad hoc basis (i.e. only when new data and information becomes available).

The local server 204 includes a scheduling module 212 which defines the order in which the data and information is presented on the display 206. For example, advertisements could be scheduled to be shown in a predefined order, or repeated a predefined number of times. Alternatively, for example, where it is known that there will be no potential interruptions to the presentation of data and information, longer advertisements may be shown.

The scheduling module 212 may be updated in any of a number of manners. In one embodiment, information regarding desired scheduling is transmitted as part of the data and information transmitted by the central server 202. This may be used to form the scheduling module 212, or alternatively, information input directly at the local server 204 may be used to form the scheduling information which is provided to the scheduling module 212. In a third possible embodiment, both information from the central server 202 and the local server 204 may be “blended” using a suitable algorithm and/or rule set operated by the scheduling module 212.

To provide a simple example, purely for the purposes of more clearly describing an embodiment of the present invention, the central server 202 may provide a list of advertisements and other content to be played, according to the order in which they are to be played, as per Table 1 below.

TABLE 1
Order of Content to be Played

| Content to be Played | Order |
|---|---|
| Advertisement 1 | 1 |
| Advertisement 2 | 2 |
| Community Service Announcement 1 | 3 |
| Community Service Announcement 2 | 4 |
| Advertisement 2 | 5 |

The information of Table 1 may be provided to the scheduling module 212, along with local server information provided by a local user (say a station master who manages the local train station). The station master may wish to move “community service announcement 1” to be played first, due to the need to inform commuters of some issue (e.g. standing too close to the platform). The local user may therefore instruct the local server 204 to re-order the order of the content to be played, as shown in Table 2.

TABLE 2
Re-Ordered Order of Content to be Played

| Content to be Played | Order |
|---|---|
| Community Service Announcement 1 | 1 |
| Advertisement 1 | 2 |
| Advertisement 2 | 3 |
| Community Service Announcement 2 | 4 |
| Advertisement 2 | 5 |

As can be seen from Table 2, the content is now reordered and the scheduling module 212 would play the content in the new order, as modified by the local user.

It will be understood that the example given with reference to Tables 1 and 2 has been deliberately oversimplified, in order to provide the reader with some understanding of the manner in which the scheduling module operates. It will be understood that the scheduling module 212, in operation, may be arranged to cycle through hundreds or thousands of individual pieces of content, but the inclusion of such a detailed example is not practical in the context of the present specification.

For completeness, however, some examples of some more complex algorithms that may be utilised for operating the scheduling module 212 are described below:
1. The scheduling monitor 212 may include a dynamic table of content to be played, where the dynamic table may be updated and/or re-organised periodically through both automated updates and/or manual intervention.
2. The scheduling monitor 212 may include multiple tables of content, where the use of a particular table is dependent in part or in whole on one or more external criteria being met. For example, the scheduling monitor may have a ‘daytime’ table (e.g. 6 am to 6 pm) and a night-time table (e.g. 6 pm to 6 am) which have different content items, and the monitor may utilise one table as opposed to another table dependent on the time. Similarly, different tables may be utilised for different days of the week.

It will be understood that in some embodiments, multiple screens may be installed in a single location (e.g. along a single platform or in a single station). In the case where multiple screens are located proximate each other, each screen may either display their own individual advertisements, entertainment and/or emergency messages or alternatively, the local server may operate to simultaneously send substantively information to all screens.

In another embodiment, a separate local server may be utilised for each screen, but the local servers may be arranged to communicate with each other to ensure that content is synchronised to create a network across a single platform of a railway station, an entire railway station, or across an entire railway network. All activity may be controlled from the remote server, such that the local servers only operate to provide content to the screens. Such variations are within the purview of a person skilled in the art.

The local server is also in communication with at least one sensor 210. The at least one sensor, in the embodiment described herein, is a sensor adapted to detect the approach of a train into a train station platform. When the at least one sensor 210 detects the approach of the train into the train station platform, a signal is sent to temporarily ‘stop’ the display of any data and information on the display screen 206 and/or through the audio speakers 208.

In one embodiment, the train sensor is wireless and includes sufficient processing and storage facilities to communicate directly with the server, to trigger the server to display a message to warn commuters on the platform that a train is approaching. In other words, the sensors are dynamic and automatically communicate with the local server as required. In another embodiment, the sensors may be directly wired to the local server. In the embodiment, the screens are programmed to turn blank so as not to distract train drivers as they come into the station.

The sensors, in a preferred embodiment, are installed 280 meters from the starting point of both sides of the platform (in the tunnel if the railway network is underground) to provide enough time for the screens to cut the current programming, display a warning message and subsequently turn the screens blank before the train enters the station. It will be understood that the exact distance from the platform at which the sensors are installed may vary according to the average speed of the trains on a given network, the noise produced by the trains, or any other factors that may be important from time to time in determining the ideal location of the sensors.

In one embodiment, the sensors may be dynamically moveable depending on the type of train approaching and/or any other factor that may be judged as important in ‘fine tuning’ the shutdown/start-up times of the screens.

In one embodiment, the screen includes a fail-safe mechanism which automatically turns the screen blank if any communications error occurs.

It will be understood that while the present embodiment has been described with reference to a single central server 202 and a single local server 204, the single central server 202 may interact with more than one local server 204. There may be provided multiple local servers (not shown), each which interact with the central server 202. Local servers may be deployed per train station, per geographic area, per railway platform, or in any other configuration or combination as may be required for any particular application or existing infrastructure.

For example, in a complex railway network where each railway station has some measure of autonomy in how train arrivals and departures are managed, or where train arrivals and departures are volatile and difficult to predict with a high level of accuracy, a local server may be provided for each station, to allow the local operator greater control over the flow and scheduling of advertisements, entertainment and announcements. Alternatively, in a network where there are a small number of stations or where there is a low traffic (commuter) flow per station, a single local server may serve multiple stations.

At FIG. 3, there is shown a railway tunnel including railway tracks 300, a railway car 302 and a screen 304 in situ. As can be seen, the screen 304 is the only feature of the system that is visible to the commuter.

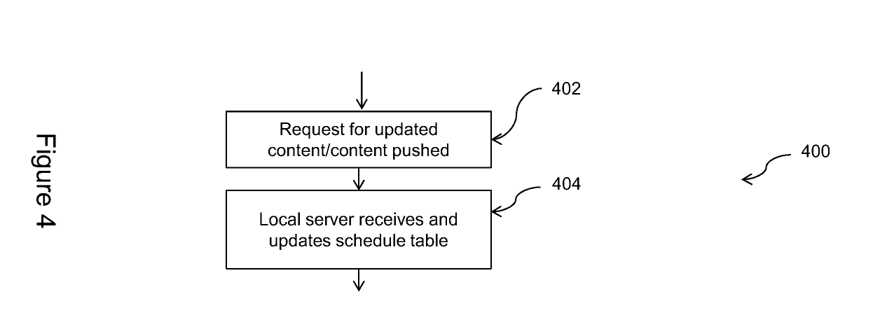

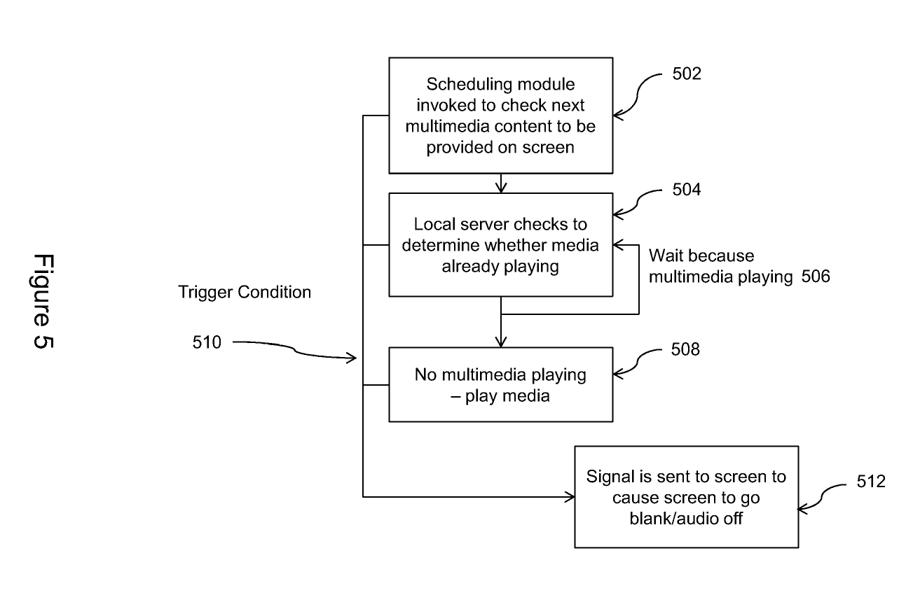

Turning now to FIGS. 4 and 5, there are depicted processes for uploading and scheduling content, and for displaying content in accordance with an embodiment of the present invention, respectively.

Referring to FIG. 4, there is shown a process flow, generally depicted by 400, for uploading and scheduling content. At step 402, the local server makes a request for updated content from the central server. This request may occur at predetermined intervals, or may occur in an ad hoc fashion. Alternatively, content may be ‘pushed’ from the central server to the local server.

Once content is available at the local server, then at step 404, the local server receives and/or updates a schedule table, which provides information on how the content is to be transmitted to the screen.

Turning to FIG. 5, there is shown a process flow, generally depicted by 500, for displaying content. At step 502, the local server invokes the scheduling module to check the next multimedia content to be provided to the screen. At step 504, the local server then checks to determine whether the screen is currently playing multimedia content or if there is a trigger event. If there is no multimedia content being played and no trigger event, then at step 506, the multimedia content scheduled is provided to the screen. Otherwise, at step 508, the local server waits for a predetermined time to before returning to step 504. A trigger condition (510) may also occur at any time (i.e. during any one of steps 502 through 508. If a trigger condition 510 occurs, the process flow jumps to step 512, where a signal is sent to the screen to cause the screen to go blank.

### Advantages

The advertising industry is moving to digital media to replace labour intensive conventional print media where possible. One specific embodiment of the invention is provided under the brand name “Lunalite Cross Track Digital (XTD)”™ and is targeted to the railway networks in various capital cities around the world. The system is attractive to station managers as the system increases revenue and offers commuters entertainment, information, and paid advertising while waiting for a train to arrive at the station.

The embodiment described above utilises colour LED screens that are built to withstand harsh outdoors or high traffic environments and are approximately sixteen times larger than a 50 inch domestic plasma or LCD television. When fully installed the screens extend only 10 centimetres away from the station's cross track wall, thereby not interfering with the train cars of a train as it passes through the railway station. The screen is housed in a matt black pressed metal housing (to prevent glare from lights) which acts as part of the structure for mounting the screen and also houses an on-board computing system which handles data connectivity with the local server 204. Internal stereo speakers offer sound for TV commercials, news flash and movie previews.

As such, the system in accordance with the embodiment provides a simple to install, yet effective advertising and content delivery medium for delivery of advertising and content to commuters in a railway station.

### Alterations and Modifications to the Embodiments

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

In particular, reference in the embodiment described above has been limited to a railway environment. However, it will be understood that the same inventive concept may be applied to any one of a number of settings or situations. For example, without limitation, embodiments of the invention may find use in:
1. Any public space, such as a park, a shopping centre, a town square, a public gathering area, a beach, etc. In such situations, the advertisements and content may be triggered by a sensor that is arranged to start and/or stop the screen according to any suitable criteria, such as the presence of people in the area (e.g. the screen only plays content when motion detectors detect the presence of one or more people in the vicinity of the screen).
2. In a private setting, such as in a retail outlet, a lobby of a building, etc., where again, the advertisements and content may be triggered by a sensor that is arranged to start and/or stop the screen according to any suitable criteria.

Moreover, it will be understood that the system described herein could be integrated into other existing or new systems, as required for any particular purpose. As such, in addition to the features recited herein above, embodiments of the invention may include:
1. the ability to receive or transmit data in a compressed and/or encrypted format;
2. the inclusion of data collecting devices, such as microphones, still or video cameras, etc., which may subsequently relay information to the local server, the central server, or a third party server;
3. the ability for authorised third parties (e.g. police, emergency rescue services, etc.) to override the central server and/or the local server to ‘seize control’ of the screens for the purpose of transmitting emergency announcements;
4. the ability of the screens to provide some level of interactivity, such that commuters may use mobile devices, such as mobile telephones, to communicate directly or indirectly with the local server or the central server to provide feedback, play interactive games, etc.;
5. the integration of the system into existing systems, such as residing on the same server or being in communication with a railway signals server or any other server; and/or
6. the ability of the system to transmit diagnostic information to aid in troubleshooting.

Although not required, the software aspects of the embodiments described with reference to the Figures can be implemented as an Application Programming Interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by a computing system or partly implemented by computing systems then any appropriate computing system architecture may be utilised. This will include stand-alone computers, network computers and dedicated hardware devices, such as programmable arrays. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A system for delivering content, comprising:
a local server arranged to provide multimedia content to a device, and a sensor in communication with the local server;
wherein the sensor monitors for an event, and on the sensor being triggered by the occurrence of the event, the sensor sends a signal to the local server to cause the local server to modify the provision of content to the device.

2. A system in accordance with claim 1, further including a central server arranged to provide content to the device.

3. A system in accordance with claim 1, wherein the local server further includes a scheduling module, arranged to provide one or more of a plurality of multimedia content to the device in a predetermined order.

4. A system in accordance with claim 2, wherein the scheduling monitor receives additional scheduling information wherein the additional scheduling information is utilised by the scheduling module to modify the predetermined order of the content.

5. A system in accordance with claim 1, wherein the local server is arranged to autonomously retrieve content from at least one external source.

6. A system in accordance with claim 1, wherein the local server is arranged to, upon receiving the trigger event from the sensor, cause the device stop displaying the content.

7. A system in accordance with claim 6, wherein at least one of the sensor and the local server, and the local server and the remote server communicate wirelessly.

8. A system in accordance with claim 1, wherein there are provided a plurality of devices, wherein the local server provides content to each of the plurality of devices.

9. A system in accordance with claim 1, wherein there are provided a plurality of local servers which form a network of local servers, each local server being associated with one or more devices, wherein each one of the plurality of local servers is arranged to synchronise with each other, such that similar content is provided to each one of the one devices under the control of the plurality of local servers.

10. A system in accordance with claim 1, wherein the multimedia content includes at least one of advertisements, entertainment and emergency announcements.

11. A system in accordance with claim 1, wherein the device is a multimedia screen, such as a LED monitor.

12. A system in accordance with claim 1, wherein the system is partially or wholly located within a railway station.

13. A method for delivering content, comprising the steps of:
providing multimedia content to a device via a local server, and monitoring for an event, via a sensor;
wherein on the sensor being triggered by the occurrence of the event, a signal is sent to the local server to cause the local server to modify the provision of content to the device.

14. A computer program including at least one instruction which, when executed on a computing system, causes the computing system to carry out the method steps of claim 13.

15. A computer readable medium incorporating a computer program in accordance with claim 14.

16. A data signal including at least one executable instruction, which, when received by a computing system, causes the computing system to carry out the method steps of claim 13.
